(19) United States
(12) Patent Application Publication
(10) Pub. No.: US 2002/0186403 A1
(43) Pub. Date: Dec. 12, 2002

(54) Image forming apparatus

(75) Inventor: Jin Okimoto, Tokyo (JP)

Correspondence Address: Johnny A. Kumar, FOLEY & LARDNER, Washington Harbour, 3000 K Street, N.W., Suite 500, Washington, DC, 20007-5109, US

(73) Assignee: TOSHIBA TEC KABUSHIKI KAISHA

(21) Appl. No.: 09/874,263

(22) Filed: Jun. 6, 2001

(51) Int. Cl. B41F 1/00; G06F 15/00

(52) U.S. Cl. 358/1.15; 358/1.16

(57) ABSTRACT

When performing rotation and compression processing of image data, judgment is made upon whether image data for n lines is white, compression processing is carried out without performing rotation processing if the image data is white, and rotation processing is effected in units of n×n and then compression processing is carried out if the image data is not white.

### BACKGROUND OF THE INVENTION

The present invention relates to an image forming apparatus such as an electronic copying machine, and more particularly to an image forming apparatus for forming an image by performing rotation and compression processing.

Conventionally, as the basic operation for effecting rotation and compression of image data, rotation processing is conducted with respect to a block consisting of n pixels×n pixels, and compression processing is thereafter carried out with respect to the rotated image data. This is performed to all the blocks of the image data.

In such a method, however, all bits of the image data must be retrieved twice for the rotation processing and the compression processing, respectively. This leads to a problem that the rotation and compression processing cannot be performed at high speed.

### BRIEF SUMMARY OF THE INVENTION

It is an object of the present invention to provide an image forming apparatus capable of increasing the speed of the rotation and compression processing of the image data.

To achieve this aim, according to the present invention, there is provided an image forming apparatus comprising: first storing means for storing image data; judging means for dividing the image data stored in the first storing means into a plurality of blocks and making judgment upon whether all pixels are white in accordance with each of the divided blocks; rotation processing means for performing rotation processing of image data of a block when it is determined that not all pixels in the block are white by the judging means; controlling means for controlling to omit rotation processing of image data of a block when it is determined that all pixels are white in the block by the judging means; compressing means for compressing image data of a block which skips rotation processing by the controlling means or image data of a block subjected to rotation processing by the rotation processing means and determining resulting data as code data; and second storing means for storing the code data compressed by the compressing means.

According to the present invention, there is provided an image forming apparatus comprising: first storing means for storing image data; judging means for dividing the image data stored in the first storing means into a plurality of blocks and making judgment upon whether all pixels are white in accordance with each of the divided blocks; rotation processing means for performing rotation processing of image data of a block when it is determined that not all pixels in the block are white by the judging means; second storing means for storing image data of a block subjected to rotation processing by the rotation processing means; controlling means for controlling to omit rotation processing of image data of a block when it is determined that all pixels in the block are white by the judging means; compressing means for compressing image data of a block which skips rotation processing by the controlling means or image data of a block stored in the second storing means and determining resulting data as code data; and third storing means for storing the code data compressed by the compressing means.

According to the present invention, there is provided an image forming apparatus which has compressing means for compressing image data and forms an image, the image forming apparatus comprising: first storing means for storing image data; judging means for dividing image data stored in the first storing means into a plurality of blocks, performing bit retrieval in accordance with each of the divided blocks, and making judgment upon whether all pixels of each of the blocks are white; rotation processing means for performing rotation processing of image data of a block which is determined that not all pixels thereof are white by the judging means; second storing means for storing image data of a block subjected to rotation processing by the rotation processing means; first controlling means for performing bit retrieval of image data of a block stored in the second storing means, compressing the image data by the compressing means, and determining resulting data as code data; second controlling means for compressing by the compressing means image data of a block determined that all pixels thereof are white by the judging means, and determining resulting data as code data; and third storing means for storing the code data controlled and compressed by the first controlling means or the code data controlled and compressed by the second controlling means.

### BRIEF DESCRIPTION OF SEVERAL VIEWS OF THE DRAWING

FIG. 1 is a cross-sectional view schematically showing an internal structure of a digital copying machine according to an image forming apparatus of the present invention;

FIG. 2 is a block diagram schematically showing a flow of a signal for electrical connection and control of the digital copying machine depicted in FIG. 1;

FIG. 3 is a block diagram showing a structure of a primary part according to the present invention in a main control portion;

FIG. 4 is a view showing a procedure for creating code data from image data stored in a page memory;

FIG. 5 is a view illustrating rotation processing;

FIG. 6 is a flowchart for illustrating the operation of the rotation processing and compression processing;

FIG. 7 is a flowchart for illustrating the detailed operation of the rotation processing in the case of a non-white block;

FIG. 8 is a view showing a flow of image data in the case of a non-white block; and

FIG. 9 is a view showing a flow of image data in case of a white block.

### DETAILED DESCRIPTION OF THE INVENTION

An embodiment according to the present invention will now be described with reference to the accompanying drawings.

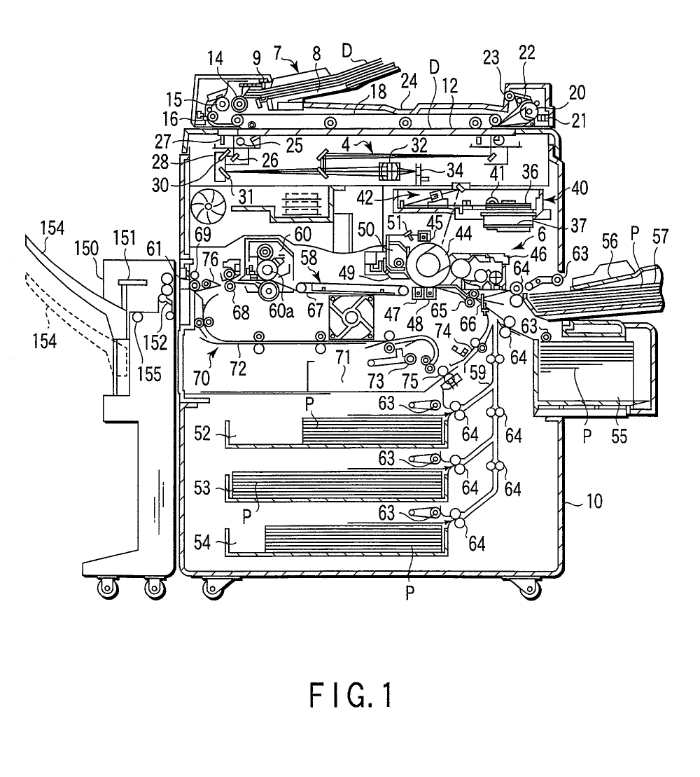

FIG. 1 is a cross-sectional view showing an internal structure of a digital copying machine (DPPC) according to an image forming apparatus of the present invention.

As shown in FIG. 1, the digital copying machine is provided with an apparatus main body 10, and a scanner portion 4 functioning as an image reader and a printer portion 6 serving as image forming means are provided in the apparatus main body 10.

An original mount base 12 consisting of transparent glass on which a reading target, i.e., an original D is mounted is provided on the top surface of the apparatus main body 10. Further, an automatic original feeder 7 (which will be referred to as an ADF hereinafter) for automatically feeding an original onto the original mount base 12 is provided on the top surface of the apparatus main body 10. This ADF 7 is provided so as to be capable of opening and closing with respect to the original mount base 12, and functions as an original presser which presses the original D mounted on the original mount base 12 against the original mount base 12.

The ADF 7 includes: an original tray 8 in which the original D is set; an empty sensor 9 for detecting existence/absence of the original; a pickup roller 14 for taking out the originals from the original tray 8 one by one; a paper feed roller 15 for carrying the original taken out; a pair of aligning rollers for aligning the end of the original; and a carrying belt 18 arranged so as to cover substantially the entire original mount base 12. Furthermore, a plurality of pieces of the original set in the original tray 8 upwards are sequentially taken out beginning from the lowermost page, i.e., the final page and aligned by a pair of the aligning rollers 16. Thereafter, they are carried to a predetermined position of the original mount base 12 by the carrying belt 18.

In the ADF 7, a reversal roller 20, a non-reversal sensor 21, a flapper 22 and a paper ejection roller 23 are arranged at the end opposed to a pair of aligning rollers 16 with the carrying belt 18 therebetween. The original D whose image information read by the later-described scanner portion 4 is fed out from the top of the original mount base 12 by the carrying belt 18 and ejected onto an original ejection portion 24 on the top surface of the ADF 7 through the reversal roller 20, the flapper 21 and the paper ejection roller 22. In the case of reading the back side of the original D, by switching the flapper 22, the original D carried by the carrying belt 18 is reversed by the reversal roller 20 and then supplied to a predetermined position on the original mount base 12 by the carrying belt 18 again.

The scanner portion 4 provided in the apparatus main body 10 has an exposure lamp 25 as a light source for illuminating the original D mounted on the original mount base 12, and a first mirror 26 for deflecting a reflected light from the original D in a predetermined direction. The exposure lamp 25 and the first mirror 26 are attached to a first carriage 27 arranged below the original mount base 12.

The first carriage 27 is arranged so as to be capable of moving in parallel with the original mount base 12, and reciprocated under the original mount base 12 by a non-illustrated scanning motor through a non-illustrated toothed belt and the like.

In addition, a second carriage 28 capable of moving in parallel with the original mount base 12 is provided below the original mount base 12. Second and third mirrors 30 and 31 for sequentially deflecting the reflected light from the original D which has been deflected by the first mirror 26 are attached to the second carriage 28 at right angles. The second carriage 28 is caused to follow the operation of the first carriage 27 by the toothed belt and the like for driving the first carriage 27, and is moved in parallel with the first carriage along the original mount base 12 at ½ the speed.

Additionally, an imaging forming lens 32 for converging the reflected light from the third mirror 31 on the second carriage 28 and a CCD (charge coupled device) 34 for receiving the reflected light converged by the image forming lens and photoelectrically-transferring the received light are provided below the original mount base 12. The image forming lens 32 is provided within a plane including an optical axis of the light deflected by the third mirror 31 so as to be capable of moving through a driving mechanism and forms an image of the reflected light with a desired magnification by moving by itself. Further, the CCD 34 photoelectrically-transfers the reflected light incident thereupon and outputs an electrical signal according to the read original D.

On the other hand, the printer portion 6 is provided with a laser exposure device 40 serving as latent image forming means. The laser exposure device 40 includes: a semiconductor laser 41 as a light source; a polygon mirror 36 as a scanning member for continuously deflecting a laser beam outgoing from the semiconductor laser 41; a polygon motor 37 as a scanning motor for driving to rotate the polygon mirror 36 with a predetermined number of revolutions; and an optical system 42 for deflecting the laser beam from the polygon mirror 36 and leading it to a photosensitive drum 44 which will be described later. The laser exposure device 40 having such a structure is fixed to and supported by a non-illustrated support frame of the apparatus main body 10.

The semiconductor laser 41 is controlled to be turned on/off in accordance with image information of the original D read by the scanner portion 4 or document information and the like transmitted/received by a facsimile. The laser beam is directed to the photosensitive drum 44 through the polygon mirror 36 and the optical system 42 and scans the peripheral surface of the photosensitive drum 44, thereby forming an electrostatic latent image on the peripheral surface of the photosensitive drum 44.

Furthermore, the printer portion 6 has the rotatable photosensitive drum 44 as an image carrier which is provided at substantially the center of the apparatus main body 10, and the peripheral surface of the photosensitive drum 44 is exposed by the laser beam from the laser exposure device 40, thereby forming a desired electrostatic latent image. Around the photosensitive drum 44 are sequentially arranged an electrostatic charger 45 for charging the peripheral surface of the drum to a predetermined charge, a developer 46 which supplies toner as a developing agent to the electrostatic latent image formed on the peripheral surface of the photosensitive drum 44 and develops at the desired image density, a transfer charger 48 which integrally has a release charger 47 for separating a transferred material, i.e., copy paper P from the photosensitive drum 44 and transfers a toner image formed on the photosensitive drum 44 onto the paper P, a release claw 49 for releasing the copy paper P from the peripheral surface of the photosensitive drum 44, a cleaning device 50 for cleaning the toner remaining on the peripheral surface of the photosensitive drum 44, and a charge eliminator 51 for eliminating the electric charge on the peripheral surface of the photosensitive drum 44.

An upper cassette 52, a middle cassette 53 and a lower cassette 54 which can be pulled out from the apparatus main body respectively are provided on the lower portion in the apparatus main body 10 in a vertically-ordered manner, and copy paper sheets of different sizes are loaded in the respective cassettes. A high-volume feeder 55 is provided on the side of these cassettes, and approximately 300 sheets of copy paper P of a frequently used size, for example the copy paper P of the A4 size are accommodated in the high-volume feeder 55. Furthermore, a paper feed cassette 57 which also serves as a manual feed tray 56 is detachably mounted on the upper portion of the high-volume feeder 55.

A carrying path 58 extending through a transfer portion positioned between the photosensitive drum 44 and the transfer charger 48 from each cassette and the high-volume feeder 55 is formed in the apparatus main body 10, and a fixer 60 having a fixing lamp 60a is provided at the tail end of the carrying path 58. A discharge port 61 is formed at the side wall of the apparatus main body 10 opposed to the fixer 60, and a finisher 150 of a single tray is attached to the discharge port 61.

Each pickup roller 63 which takes out the paper P one by one from the cassette or the high-volume feeder is provided in the vicinity of the upper cassette 52, the middle cassette 53, the lower cassette 54 and the paper feed cassette 57 and in the vicinity of the high-volume feeder 51. Further, a plurality of pairs of paper feed rollers 64 for carrying the copy paper P taken out by the pickup roller 63 through the carrying path 58 are provided on the carrying path 58.

In the carrying path 58, a pair of resist rollers 65 are provided on the upstream side of the photosensitive drum 44. The pair of the resist rollers 65 correct the inclination of the copy paper P taken out, align the end of the toner image on the photosensitive drum 44 with the end of the copy paper P, and feed the copy paper P to the transfer portion at the same speed as the moving speed of the peripheral surface of the photosensitive drum 44. A pre-alignment sensor 66 for detecting reach of the copy paper P is provided in front of a pair of resist rollers 65, namely, on the paper feed roller 64 side.

The copy paper P taken out one by one from each cassette or the high-volume feeder 55 by the pickup rollers 63 is supplied to the pair of the resist rollers 65 by a pair of paper feed rollers 64. Subsequently, after the end of the copy paper P is aligned by a pair of resist rollers 65, the copy paper P is supplied to the transfer portion.

In the transfer portion, a developer image formed on the photosensitive drum 44, i.e., a toner image is transferred onto the paper P by the transfer charger 48. The copy paper P on which the toner image is transferred is released from the peripheral surface of the photosensitive drum 44 by the action of the release charge 47 and the release claw 49 and carried to the fixer 60 through the carrying belt 67 constituting a part of the carrying path 58. Then, after the developer image is melted and fixed on the copy paper P by the fixer 60, the copy paper P is ejected onto the finisher 150 through the discharge port 61 by a pair of paper feed rollers 68 and a pair of paper eject rollers 69.

An automatic double-side device 70 for reversing the copy paper P which has passed through the fixer 60 and again feeding it to a pair of the resist rollers 65 is provided below the carrying path 58. The automatic double-side device 70 includes: a temporary accumulation portion 71 for temporarily accumulating the copy paper P; a reversal path 72 which branches from the carrying path 58, reverses the copy paper P which has passed through the fixer 60 and leads it to the temporary accumulation portion 71; a pickup roller 73 for taking out pieces of copy paper P accumulated in the temporary accumulation portion one by one; and a paper feed roller 75 for feeding the taken-out paper to a pair of resist rollers 65 through the carrying path 74. Furthermore, a distribution gate 76 for selectively distributing the copy paper P to the discharge port 61 or a reversal path 72 is provided at a branch point of the carrying path 58 and the reversal path 72.

In the case of performing double-sided copying, the copy paper P which has passed through the fixer 60 is led to the reversal path 72 by the distribution gate 76 and temporarily accumulated in the temporary accumulation portion 71 in the reversed state. Thereafter, the copy paper P is fed to the resist rollers 65 through the carrying path 74 by the pickup rollers 73 and a pair of the paper feed rollers 75. Then, the copy paper P is aligned by the resist rollers 65 and thereafter fed to the transfer portion again. Moreover, a toner image is transferred onto the back side of the copy paper P. Thereafter, the copy paper P is ejected to the finisher 150 through the carrying path 58, the fixer 60 and the paper eject roller 69.

The finisher 150 staples and rolls up each copy of ejected document. Every time a sheet of the copy paper P to be stapled, is ejected from the discharge port 61, the paper copy P is moved to the side where it is stapled, and then aligned by a guide bar 151. When all the sheets of the copy paper P are ejected, a paper pressing arm 152 presses the ejected copy paper P in units of each copy, and a stapler unit (not shown) staples the copy paper P. Thereafter, a guide bar 151 moves down, and the stapled copy paper P is ejected in units of each copy to a finisher ejection tray 154 by a finisher ejection roller 155. An amount of downward movement of the finisher ejection tray 154 is determined to some degree by the number of sheets of the copy paper P to be ejected, and the finisher ejection tray 154 moves down in incremental steps every time each copy of the copy paper P is ejected. In addition, the guide bar 151 for aligning the copy paper P to be ejected is positioned at a high position such that it is not brought into contact with the stapled copy paper P mounted on the finisher ejection tray 154.

Additionally, the finisher ejection tray 154 is connected to a shift mechanism (not shown) which shifts (for example, in four directions of front, back, right and left) in accordance with each copy in the sort mode.

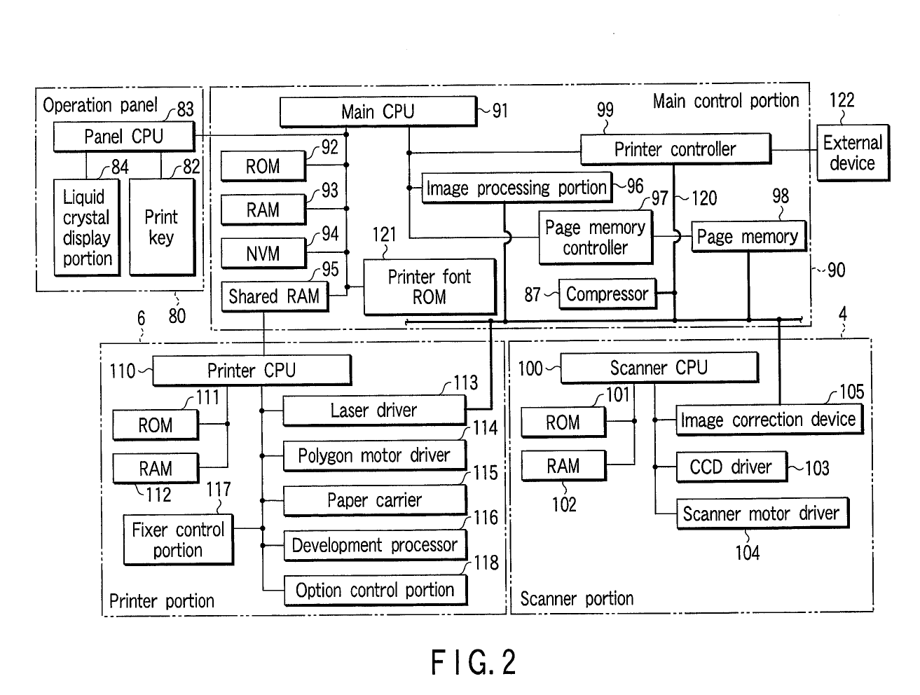

FIG. 2 is a block diagram schematically showing a flow of a signal for electrical connection and control of the digital copying machine illustrated in FIG. 1. As shown in FIG. 2, in the digital copying machine, three CPUs, i.e., a main CPU 91 in a main control portion 90, a scanner CPU 100 in the scanner portion 4 and a printer CPU 110 in the printer portion 6 are constituted. The main CPU 91 performs bi-directional communication with the printer CPU 110 through a shared RAM 95, the main CPU 91 only issues operational commands, and the printer CPU 110 returns the statuses. The printer CPU 110 and the scanner CPU 100 carry out serial communication, the printer CPU 110 issues the operational commands, and the scanner CPU 100 returns the statuses.

An operation panel 80 is connected to the main CPU 91.

The main control portion 90 is constituted by the main CPU 91, a ROM 92, a RAM 93, an NVM 94, the shared RAM 95, an image processing portion 96, a page memory control portion 97, a page memory 98, a printer controller 99, and a printer font ROM 121.

The main CPU 91 controls the entire main control portion 90. The ROM 92 stores therein a control program. The RAM 93 temporarily stores data.

An NVM (endurable random-access memory: nonvolatile RAM) 94 is a nonvolatile memory backed up by a battery (not shown), and data on the NVM 94 is held when the power supply is turned off.

The shared RAM 95 is used for performing bi-directional communication between the main CPU 91 and the printer CPU 110.

The page memory controller 97 stores or reads image data to or from the page memory 98. The page memory 98 has an area in which image data corresponding to a plurality of pages can be stored, and is formed so as to be capable of storing data obtained by compressing the image data from the scanner portion 4 in accordance with one page.

Further, a compression portion 87 for compressing image data is connected to the page memory controller 97.

Font data corresponding to print data is stored in the printer font ROM 121.

The printer controller 99 develops the print data from an external device 122 such as a personal computer into image data by using the font data stored in the printer font ROM 121 with a resolution according to data representing a resolution given to that print data.

The scanner portion 4 is constituted by: the scanner CPU 100 for controlling the entire scanner portion 4; a ROM 101 in which a control program and others are stored; a RAM 102 for storing data; a CCD driver 103 for driving the CCD sensor 34; a scan motor driver 104 for controlling the exposure lamp 25 and the rotation of a motor for moving the mirrors 26, 27 and 28 and others; an A/D conversion circuit for converting an analog signal from the CCD sensor 34 into a digital signal; a shading correction circuit for correcting fluctuations of a threshold level relative to an output signal from the CCD sensor 34 which are caused due to irregularities of the CCD sensor 34 or a change in the ambient air temperature; and an image correction portion 105 consisting of a line memory for temporarily storing a shading-corrected digital signal from the shading correction circuit.

The printer portion 6 is constituted by: a printer CPU 110 for controlling the entire printer portion 6; a ROM 111 in which a control program and others are stored; a RAM 112 for storing data; a laser driver 113 for turning on/off the light emission by the semiconductor laser 41; a polygon motor driver (motor controller) 114 for controlling the rotation of the polygon motor 37 of the laser unit 40; a paper carrying portion 115 for controlling carriage of the paper P by the carrying path 58; an electrostatic charger 45; a developer 46; a development process portion 116 for performing electrostatic charge, development and transfer by using the transfer charger 48; a fixer control portion 117 for controlling the fixer 60; and an option portion 118.

Furthermore, the image processing portion 96, the page memory 98, the printer controller 99, the image correction portion 105, and the laser driver 113 are connected by an image data bus 120.

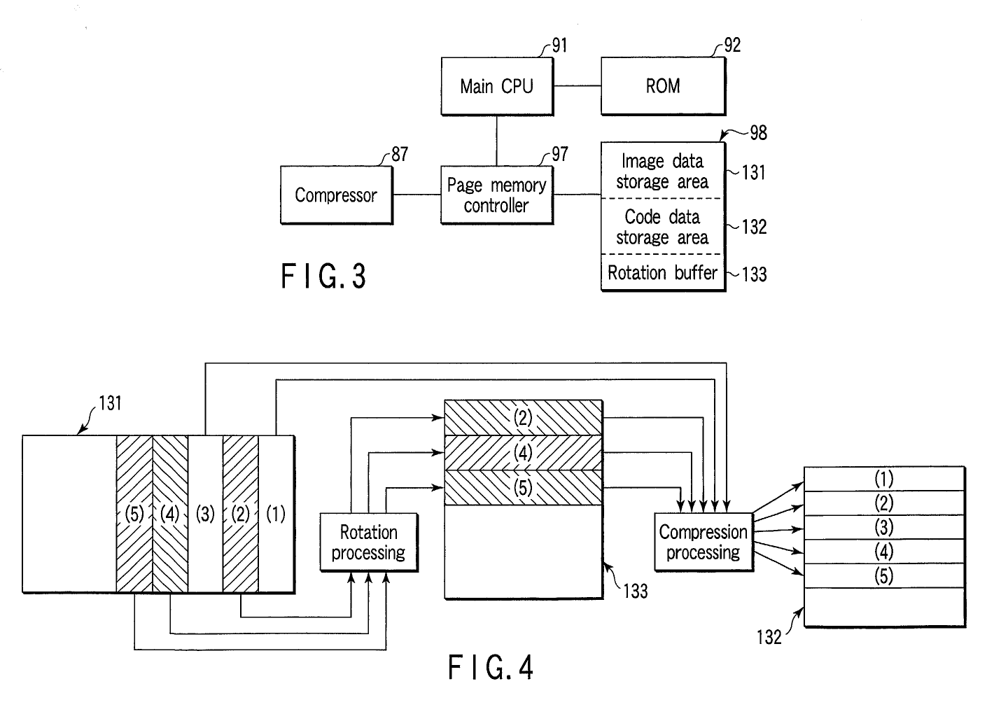

FIG. 3 shows the structure of a primary portion according to the present invention in the main control portion 90. That is, the ROM 92 in which a control program is stored and the page memory controller 97 are connected to the main CPU 91, and the compressor 87 and the page memory 98 are connected to the page memory controller 97.

The page memory 98 is controlled by the page memory controller 97 and has an image data storage area 131, a code data storage area 132 and a rotation buffer 133.

FIG. 4 shows the procedure for creating code data from image data stored in the page memory 98. The image data stored in the image data storage area 131 of the page memory 98 is subjected to rotation processing and compression processing in accordance with each block.

The image data which has been subjected to the rotation processing is stored in the rotation buffer 133, and then subjected to the compression processing and written into the code data storage area 132.

If all the pixels in the image data are white (white block), the rotation processing is omitted and the compression processing is effected. The code data obtained after the compression processing is written in the code data storage area 132.

Next, a description will be given as to how blocks (1) to (5) in the image data shown in FIG. 4 become code data. It is assumed that all the pixels in the block (1) and the block (3) are white (white blocks) and not all the pixels in the block (2), the block (4) and the block (5) are white (non-white blocks).

It is to be noted that compression in this embodiment is MMR compression (compression using a Modified Modified READ Code). The MMR compression adopts a two-dimensional line unit coding system. A change point is determined by making reference to a line to be coded and an immediately preceding line, and coding is carried out based on the change point. As a reference line for a first coded line in a page, a white line is virtually presupposed. Moreover, as a reference line of a non-white block following a white block, a virtual white line is presupposed as being similar to the first line in the page.

Since the block (1) is a white block, the rotation processing is omitted and the compression processing is carried out. The code data after compression is written in the code data storage area 132. Since the reference line is the first line in the page, it is a virtual white line.

Since the block (2) is a non-white block, the compression processing of the image data is executed after performing the rotation processing. The code data after compression is written in the code data storage area 132. It is to be noted that the reference line of the block (2) is a virtual white line since the immediately preceding block is a white block.

Since the block (3) is a white block, the rotation processing is omitted and the compression processing is effected. The code data after compression is written in the code data storage area 132. It is to be noted that the reference line of the block (3) is a last line of the block (2) since the immediately preceding block of the block (3) is a non-white block.

Since the block (4) is a non-white block, the compression processing of the image data is carried out after performing the rotation processing. The code data after compression is written in the code data storage area 132. The reference line of the block (4) is a virtual white line since its immediately preceding block is a white block.

Since the block (5) is a non-white block, the compression processing of the image data is carried out after performing the rotation processing. The code data after compression is written in the code data storage area 132. The reference line of the block (5) is a last line of the block (4) since the immediately preceding block of the block (5) is a non-white block.

FIG. 5 illustrates the rotation processing. A rotation angle in this embodiment is determined as the rotation of 270 degrees in the clockwise direction. Further, in this embodiment, 32 bits×32 bits are determined as one cell, and 32 bits×(32×n) bits of the image data are determined as one block. It is to be noted that n is an integer. The rotation processing is carried out in accordance with each cell constituting a block.

The operation of the rotation processing and the compression processing in this structure will now be described with reference to the flowchart of FIG. 6.

The page memory controller 97 first makes judgment upon whether the processing of all the blocks of the image data stored in the image data storage area 131 of the page memory 98 is completed (ST 501).

If it is not completed, the page memory controller 97 calculates a position of a block to be processed (ST 502). Subsequently, the page memory controller 97 makes judgment (bit retrieval) upon whether that block of the image data stored in the image data storage area 131 is a white block (ST 503).

If that block is a non-white block, the page memory controller 97 performs the rotation processing of that block and stores the obtained result in the rotation buffer 133 (ST 504). Furthermore, the page memory controller 97 sets the immediately preceding line of that block in the compressor 87 as a reference line (ST 505). The page memory controller 97 bit-retrieves the image data of that block stored in the rotation buffer 133 and controls the compression processing by the compressor 87 (ST 507). Moreover, the page memory controller 97 stores the code data of that block which has been subjected to the compression processing in the code data storage area 132 of the page memory 98.

In addition, if it was found that the block is a white block by the judgment at the step ST 501, the page memory controller 97 omits the rotation processing and sets a virtual white line in the compressor 87 as a reference line (ST 506). By omitting the rotation processing in this manner, the operation for storing in the rotation buffer 133 and the bit retrieval when reading from the rotation buffer 133 are omitted. The page memory controller 97 controls to carry out the compression processing of the image data of that block by the compressor 87 (ST 507). Then, the page memory controller 97 stores the code data of that block which has been subjected to the compression processing in the code data storage area 132.

Upon completing the step ST 507, the page memory controller 97 returns to the step ST 501 and repeats the processing of the steps ST 501 to 507 until the processing of all the blocks of the image data stored in the image data storage area 131 of the page memory 98 is terminated.

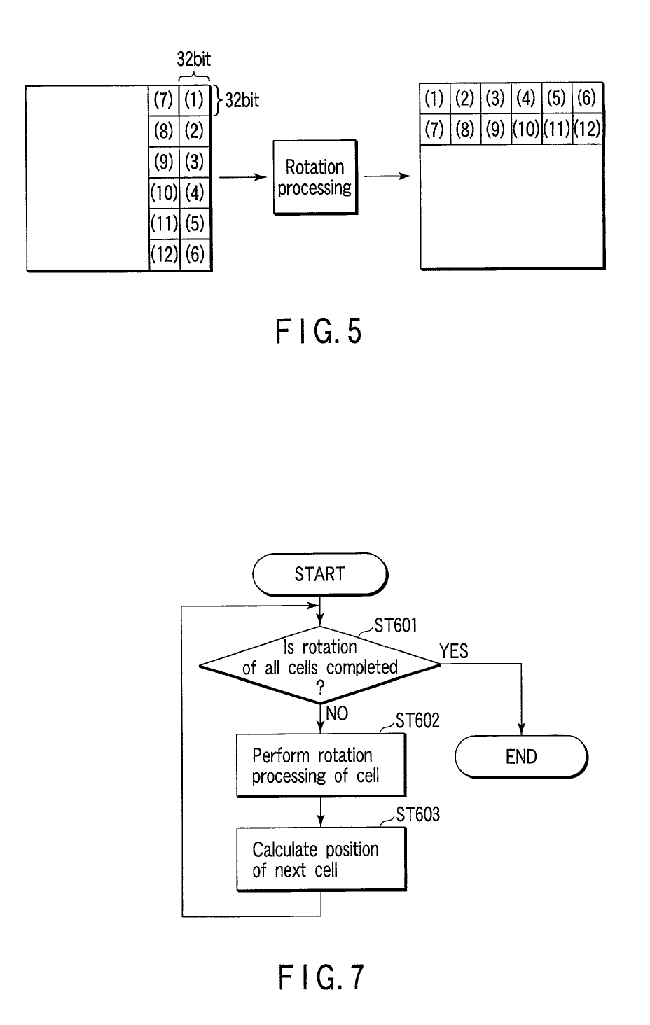

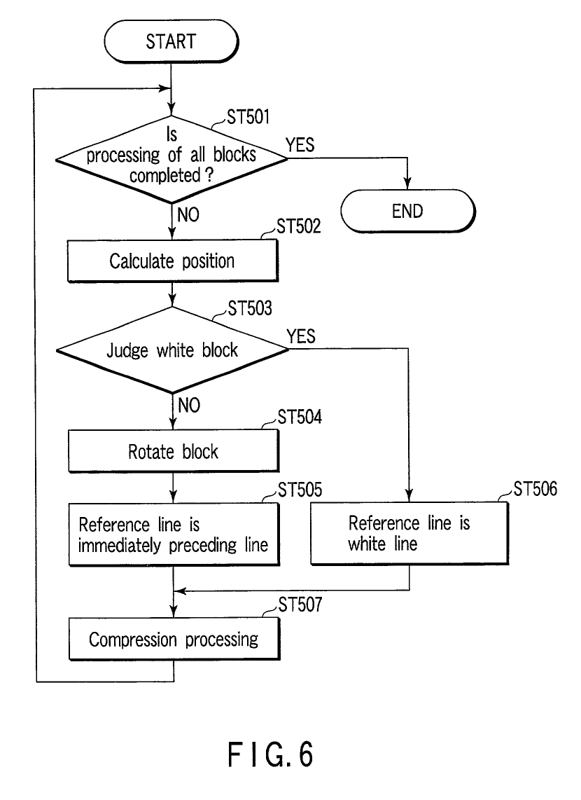

The operation of the rotation processing in a non-white block at the step ST 504 will now be described with reference to the flowchart of FIG. 7.

The page memory controller 97 first makes judgment upon whether the processing of all the cells in that block is completed (ST 601).

If it is not completed, the page memory controller 97 carries out the rotation processing of cells which are yet to be processed (ST 602), and calculates a position of a next cell (ST 603).

When the step ST 603 is completed, the page memory controller 97 returns to the step ST 601 and repeats the processing of the steps ST 601 to 603 until the rotation processing of all the cells of that block is terminated.

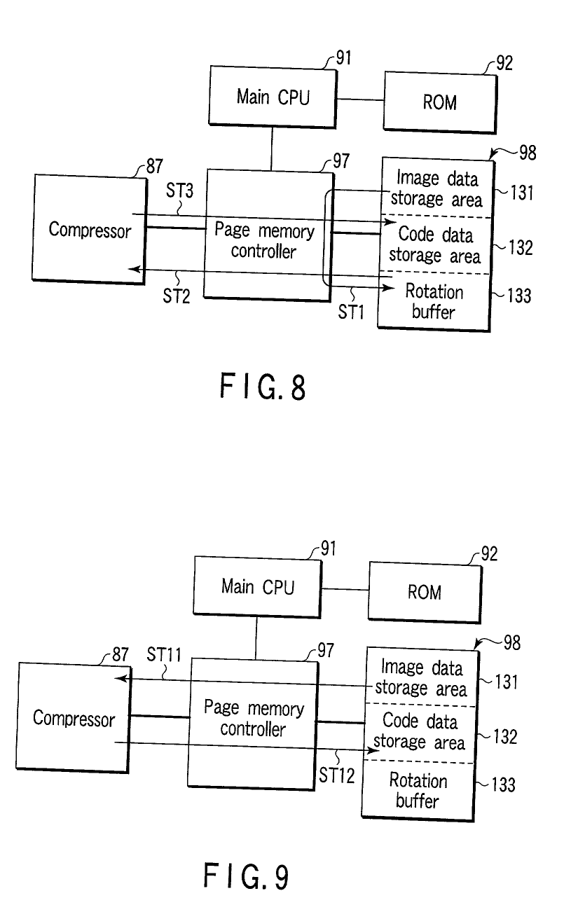

FIG. 8 shows a flow of the image data in the case of the above-described non-white block. The image data stored in the image data storage area 131 of the page memory 98 is rotated and stored in the rotation buffer 133 by the page memory controller 97 (ST 1). Subsequently, the image data which is stored in the rotation buffer 133 and has been subjected to the rotation processing is compressed by the compressor 87 under control of the page memory controller 97 (ST 2), and stored in the code data storage area 132 as the code data (ST 3).

FIG. 9 shows a flow of the image data in case of the above-described white block. The image data stored in the image data storage area 131 of the page memory 98 is compressed by the compressor 87 under control of the page memory controller 97 (ST 11), and stored in the code data storage area 132 as the code data (ST 12).

As described above, according to the embodiment of the present invention, as to the basic operations, i.e., rotation and compression of the image data, the rotation processing is carried out in units of n pixels×n pixels, and the compression processing is effected with respect to that image data. However, in the present invention, it is good enough to perform the bit retrieval for the white line only once by omitting the rotation processing, and the speed of the rotation and compression processing can be increased.

In the above-described embodiment, it is to be noted that the rotation processing is executed by software in the page memory controller but a rotation processing portion may be provided as means for executing the rotation processing by hardware.

What is claimed is:

1. An image forming apparatus comprising:
first storing means for storing image data;
judging means for dividing said image data stored in said first storing means into a plurality of blocks and making judgment upon whether all pixels are white in accordance with each of said divided blocks;
rotation processing means for performing rotation processing of image data of a block when it is determined that not all pixels in said block are white by said judging means;
controlling means for controlling to omit rotation processing of image data of a block when it is determined that all pixels are white in said block by said judging means;
compressing means for compressing image data of a block which skips rotation processing by said controlling means or image data of a block subjected to rotation processing by said rotation processing means and determining resulting data as code data; and
second storing means for storing said code data compressed by said compressing means.

2. The image forming apparatus according to claim 1, wherein said first storing means and said second storing means are provided for a page memory.

3. The image forming apparatus according to claim 1, wherein said judging means divides image data into blocks in units of a plurality of lines in said image data.

4. The image forming apparatus according to claim 1, wherein said judging means divides image data into a plurality of blocks in units of 32-bit lines in said image data.

5. The image forming apparatus according to claim 1, wherein said rotation processing means carries out rotation processing in units of one cell with n bits×n bits constituting a block being determined as one cell.

6. The image forming apparatus according to claim 1, wherein said rotation processing means performs rotation processing in units of one cell with 32 bits×32 bits constituting a block being determined as one cell.

7. The image forming apparatus according to claim 1, wherein said rotation processing means carries out rotation processing of 270 degrees in the clockwise direction in units of one cell with n bits×n bits constituting a block being determined as one cell.

8. The image forming apparatus according to claim 1, wherein said rotation processing means performs rotation processing of 270 degrees in the clockwise direction in units of one cell with 32 bits×32 bits constituting a block being determined as one cell.

9. The image forming apparatus according to claim 1, wherein said controlling means is a controller for controlling a page memory to which said first storing means and said second storing means are provided.

10. The image forming apparatus according to claim 1, wherein said compressing means performs compression using a Modified Modified READ Code.

11. An image forming apparatus comprising:
first storing means for storing image data;
judging means for dividing said image data stored in said first storing means into a plurality of blocks and making judgment upon whether all pixels are white in accordance with each of said divided blocks;
rotation processing means for performing rotation processing of image data of a block when it is determined that not all pixels in said block are white by said judging means;
second storing means for storing image data of a block subjected to rotation processing by said rotation processing means;
controlling means for controlling to omit rotation processing of image data of a block when it is determined that all pixels in said block are white by said judging means;
compressing means for compressing image data of a block which skips rotation processing by said controlling means or image data of a block stored in said second storing means and determining resulting data as code data; and
third storing means for storing said code data compressed by said compressing means.

12. The image forming apparatus according to claim 11, wherein said first storing means, said second storing means and said third storing means are provided for a page memory.

13. An image forming apparatus which has compressing means for compressing image data and forms an image, said image forming apparatus comprising:
first storing means for storing image data;
judging means for dividing image data stored in said first storing means into a plurality of blocks, performing bit retrieval in accordance with each of said divided blocks, and making judgment upon whether all pixels of each of said blocks are white;
rotation processing means for performing rotation processing of image data of a block which is determined that not all pixels thereof are white by said judging means;
second storing means for storing image data of a block subjected to rotation processing by said rotation processing means;
first controlling means for performing bit retrieval of image data of a block stored in said second storing means, compressing said image data by said compressing means, and determining resulting data as code data;
second controlling means for compressing by said compressing means image data of a block determined that all pixels thereof are white by said judging means, and determining resulting data as code data; and
third storing means for storing said code data controlled and compressed by said first controlling means or said code data controlled and compressed by said second controlling means.

14. The image forming apparatus according to claim 13, wherein said first storing means, said second storing means and said third storing means are provided for a page memory.

15. The image forming apparatus according to claim 13, wherein said first controlling means and said second controlling means are controllers for controlling a page memory to which said first storing means, said second controlling means and said third storing means are provided.
